(19) United States
(12) Patent Application Publication
(10) Pub. No.: US 2021/0245514 A1
(43) Pub. Date: Aug. 12, 2021

(54) IMAGE FORMING APPARATUS AND BODY OF IMAGE FORMING APPARATUS

(71) Applicants: Masatoshi ISHIDA, Kanagawa (JP); Tomoya FUJII, Kanagawa (JP); Munekazu HIRATA, Tokyo (JP)

(72) Inventors: Masatoshi ISHIDA, Kanagawa (JP); Tomoya FUJII, Kanagawa (JP); Munekazu HIRATA, Tokyo (JP)

(73) Assignee: Ricoh Company, Ltd., Tokyo (JP)

(21) Appl. No.: 17/160,740

(22) Filed: Jan. 28, 2021

(30) Foreign Application Priority Data
Feb. 10, 2020 (JP) 2020-020724
Dec. 15, 2020 (JP) 2020-207605

(51) Int. Cl. B41J 2/165

(52) U.S. Cl. CPC B41J 2/16505

(57) ABSTRACT

An image forming apparatus, movable to form an image on a recording medium, includes an image forming device, an apparatus body, and a cap. The image forming device includes an image forming face that is configured to face the recording medium. The image forming device is configured to form the image on the recording medium. The apparatus body is configured to support the image forming device. The cap is movable relative to the apparatus body between a capping position to cover the image forming face and a retracted position to be retracted from the image forming face. The retracted position is outside an area in which the image forming face is extended in a scanning direction, as viewed in a normal direction of the image forming face.

### CROSS-REFERENCE TO RELATED APPLICATIONS

This patent application is based on and claims priority pursuant to 35 U.S.C. § 119(a) to Japanese Patent Application Nos. 2020-020724, filed on Feb. 10, 2020, and 2020-207605, filed on Dec. 15, 2020, in the Japan Patent Office, the entire disclosure of each of which is hereby incorporated by reference herein.

### BACKGROUND

### Technical Field

Embodiments of the present disclosure relate to an image forming apparatus and a body of an image forming apparatus.

### Related Art

There is known an image forming apparatus that forms an image on a recording medium with an image forming face of an image forming device facing the recording medium.

### SUMMARY

In one embodiment of the present disclosure, a novel image forming apparatus, movable to form an image on a recording medium, includes an image forming device, an apparatus body, and a cap. The image forming device includes an image forming face that is configured to face the recording medium. The image forming device is configured to form the image on the recording medium. The apparatus body is configured to support the image forming device. The cap is movable relative to the apparatus body between a capping position to cover the image forming face and a retracted position to be retracted from the image forming face. The retracted position is outside an area in which the image forming face is extended in a scanning direction, as viewed in a normal direction of the image forming face.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1A is an external perspective view of a main body of a hand-held-mobile-type inkjet printer (HMP) according to an embodiment of the present disclosure, as viewed from diagonally above with a cap located at a capping position;

FIG. 1B is an external perspective view of the main body of the HMP of FIG. 1A, as viewed from diagonally above with the cap located at a retracted position;

FIG. 2A is a bottom view of the main body of the HMP, as viewed from a recording face side (i.e., bottom face side) of the main body with the cap located at the capping position;

FIG. 2B is a bottom view of the main body of the HMP as viewed from the recording face side (i.e., bottom face side) of the main body with the cap located at the retracted position;

FIG. 3 is an illustration of a state in which an image is formed on a recording material with the main body of the HMP;

FIG. 4 is a block diagram illustrating a part of an electric circuit of the main body of the HMP, according to an embodiment of the present disclosure;

FIG. 5A is a cross-sectional view of the main body of the HMP along a line A-A illustrated in FIG. 2A with a capping operation device located at a holding position;

FIG. 5B is a cross-sectional view of the main body of the HMP along the line A-A illustrated in FIG. 2A with the capping operation device located at a non-holding position;

FIG. 6 is a side view of the cap and the main body of the HMP, illustrating a position at which the cap abuts on the main body of the HMP as the cap moves to the retracted position;

FIG. 7A is a side view of the main body of the HMP, illustrating an unlocked state of an operation part;

FIG. 7B is a side view of the main body of the HMP, illustrating a locked state of the operation part;

FIG. 8A is a cross-sectional view of the main body of the HMP along the line A-A illustrated in FIG. 2A with the capping operation device located at the holding position in the unlocked state;

FIG. 8B is a cross-sectional view of the main body of the HMP along the line A-A illustrated in FIG. 2A with the capping operation device located at the non-holding position in the unlocked state;

FIG. 8C is a cross-sectional view of the main body of the HMP along the line A-A illustrated in FIG. 2A with the capping operation device located at the holding position in the locked state;

FIG. 9A is an illustration of a length of a cap changeable in a longitudinal direction of the cap, according to an embodiment of the present disclosure;

FIG. 9B is another illustration of the length of the cap of FIG. 9A changeable in the longitudinal direction of the cap;

FIG. 10A is an external perspective view of a main body of an HMP according to a first variation, as viewed from diagonally above with a cap located at a capping position;

FIG. 10B is an external perspective view of the main body of the HMP of FIG. 10A, as viewed from diagonally above with the cap located at a retracted position;

FIG. 11 is an illustration of a state in which the cap is removed from the main body of the HMP according to the first variation;

FIG. 12 is a perspective view of the cap removed from the main body of the HMP according to the first variation;

FIG. 13A is a side view of a main body of an HMP according to an example of a second variation, with a cap located at a capping position;

FIG. 13B is a side view of the main body of the HMP of FIG. 13A, with the cap located at a retracted position;

FIG. 14A is a side view of a main body of an HMP according to another example of the second variation, with a cap located at a capping position; and

FIG. 14B is a side view of the main body of the HMP of FIG. 14A, with the cap located at a retracted position.

The accompanying drawings are intended to depict embodiments of the present disclosure and should not be interpreted to limit the scope thereof. Also, identical or similar reference numerals designate identical or similar components throughout the several views.

### DETAILED DESCRIPTION

In describing embodiments illustrated in the drawings, specific terminology is employed for the sake of clarity. However, the disclosure of the present specification is not intended to be limited to the specific terminology so selected and it is to be understood that each specific element includes all technical equivalents that have a similar function, operate in a similar manner, and achieve a similar result.

Although the embodiments are described with technical limitations with reference to the attached drawing, such description is not intended to limit the scope of the disclosure and not all of the components or elements described in the embodiments of the present disclosure are indispensable to the present disclosure.

In a later-described comparative example, embodiment, and exemplary variation, for the sake of simplicity, like reference numerals are given to identical or corresponding constituent elements such as parts and materials having the same functions, and redundant descriptions thereof are omitted unless otherwise required.

As used herein, the singular forms “a,” “an,” and “the” are intended to include the plural forms as well, unless the context clearly indicates otherwise,

Referring to the drawings, wherein like reference numerals designate identical or corresponding parts throughout the several views, embodiments of the present disclosure are described below.

A description is now given of an embodiment of the present disclosure applied to a hand-held-mobile-type inkjet printer (hereinafter referred to as an HMP) serving as a portable image forming apparatus.

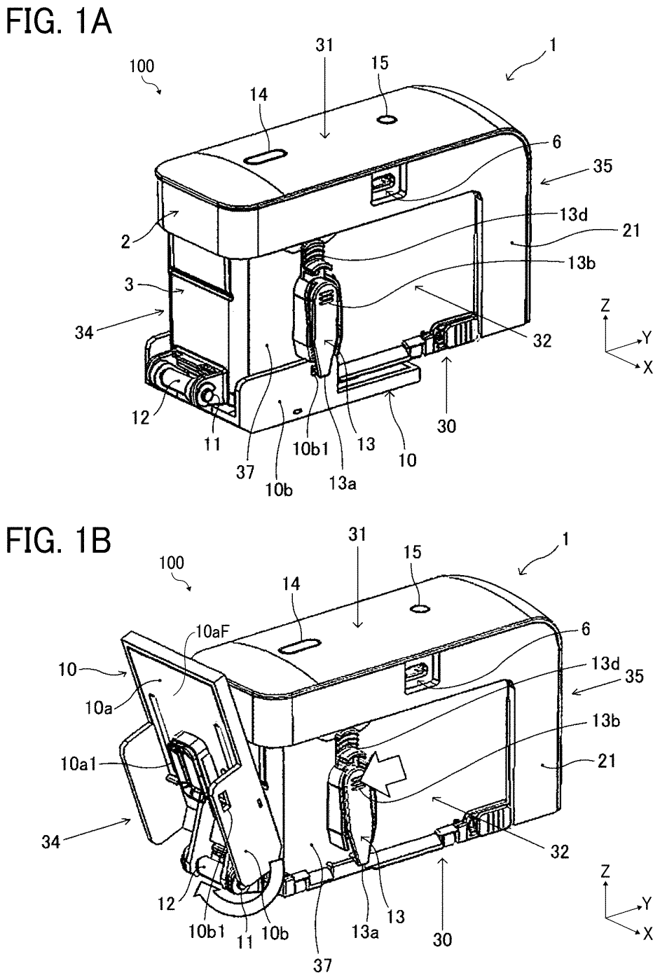

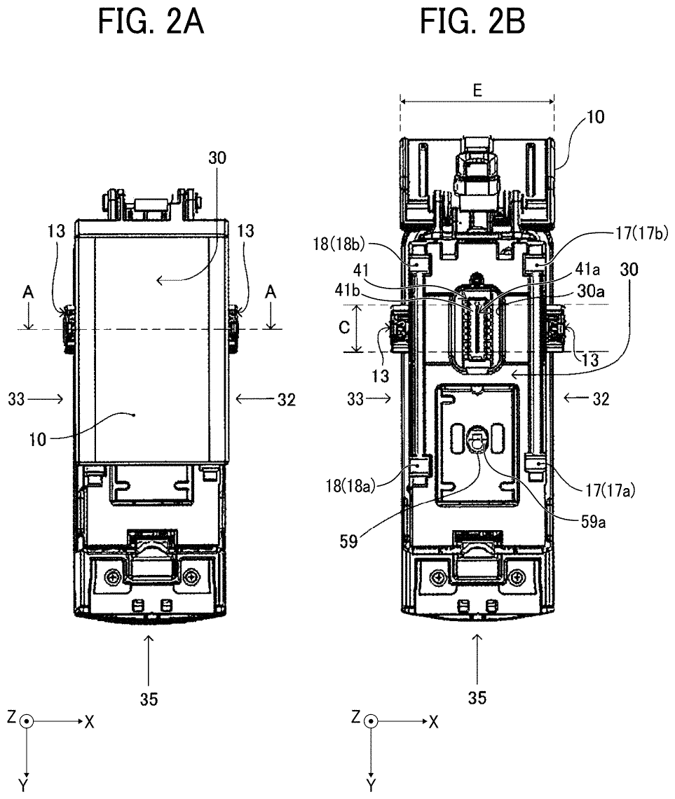

Initially with reference to FIGS. 1A to 2B, a description is now given of a basic configuration of a main body (or an apparatus body) of an HMP according to an embodiment of the present disclosure.

FIGS. 1A and 1B are external perspective views of a main body 1 (serving as an apparatus body) of an HMP 100 according to an embodiment of the present disclosure, as viewed from diagonally above.

FIGS. 2A and 2B are bottom views of the main body 1 as viewed from a recording face side (i.e., bottom face side) of the main body 1.

According to the present embodiment, the main body 1 includes an upper unit 2 and a lower unit 3 as main components of the main body 1. The main body 1 is substantially cubic as a whole. The main body 1 has a length in a scanning direction enough for a user to grasp with a palm. Note that the scanning direction is a printing direction, which is a direction indicated by arrow X in FIGS. 1A and 1B or a direction opposite the direction indicated by arrow X in FIGS. 1A and 1B. The direction indicated by arrow X is herein referred to as an X direction, whereas the direction opposite the direction indicated by arrow X is herein referred to as a −X direction.

A housing of the main body 1 includes a recording face 30 (serving as a bottom face), a top face 31 opposite the recording face 30, a left side face 32, and a right side face 33. The recording face 30 serves as an opposite face that causes a recording device 41 (serving as an image forming device) of an inkjet head 40 described later to face a recording material such as a sheet of paper. The left side face 32 and the right side face 33 extend on sides in the scanning direction of the recording face 30. The housing of the main body 1 also includes a back face 34 and a front face 35 both extending on sides in a scanning orthogonal direction of the recording face 30. The scanning orthogonal direction is a direction orthogonal to the scanning direction and indicated by arrow Y in FIGS. 1A and 1B. Note that the direction indicated by arrow Y is herein referred to as a Y direction. The main body 1 is generally used in posture directing the recording face 30 vertically downward (i.e., in a direction opposite a direction indicated by arrow Z in FIGS. 1A and 1B) with respect to the XY plane in

FIGS. 1A and 1B, while directing the top face 31 vertically upward (i.e., in the direction indicated by arrow Z in FIGS. 1A and 1B). Note that the direction indicated by arrow Z is herein referred to as a Z direction, whereas the direction opposite the direction indicated by arrow Z is herein referred to as a −Z direction. The top face 31 is provided with a print button 14 and a power button 15. The left side face 32 of the upper unit 2 is provided with a universal serial bus (USB) connection port 6. The USB connection port 6 is used to connect a USB cable to the main body 1. When electric power is supplied from an external power supply to a rechargeable battery mounted in the main body 1 via the USB cable connected to the USB connection port 6, the battery is charged.

A wide portion 21 of the upper unit 2 is located on a side of the lower unit 3 closer to the front face 35. The wide portion 21 is wider than a narrow portion 37 of the lower unit 3. A user holds and uses the main body 1 with fingers (usually, the thumb and the middle finger or the ring finger) touching the left side face 32 and the right side face 33 of the narrow portion 37 of the lower unit 3. When using the main body 1, that is, when moving the main body 1 in the scanning direction on a surface of a recording material to form an image on the recording material, the user places the fingers on the left side face 32 and the right side face 33 so as to sandwich the lower unit 3 with the wrist located closer to the wide portion 21, thus holding the main body 1.

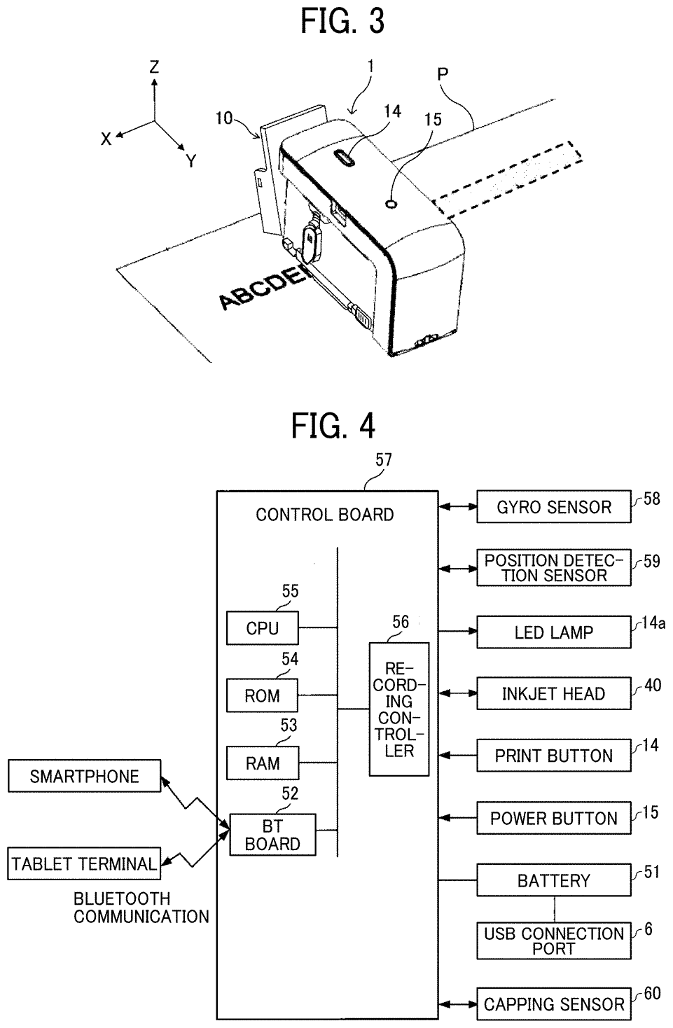

The user holds down the power button 15 to switch the power of the main body 1 between ON and OFF. With the power turned on, a control board mounted in the upper unit 2 of the main body 1 acquires image information by wireless communication with, e.g., a smartphone. After the user places the main body 1 on the surface of the recording material with the recording face 30 facing the surface of the recording material, the user presses the print button 14 once and moves the main body 1 in the scanning direction (i.e., X direction) as illustrated in FIG. 3 to form an image on a surface of a recording material P. Note that when the main body 1 reciprocates along the scanning direction during manual scanning, the main body 1 forms an image on the surface of the recording material in each of the outward path and the return path.

The recording material P, serving as a recording medium, is not limited to paper such as a sheet of paper. The recording material P may be any image forming object, such as an overhead projector (OHP) transparency, cloth, a corrugated cardboard, a packaging container, glass, or a substrate.

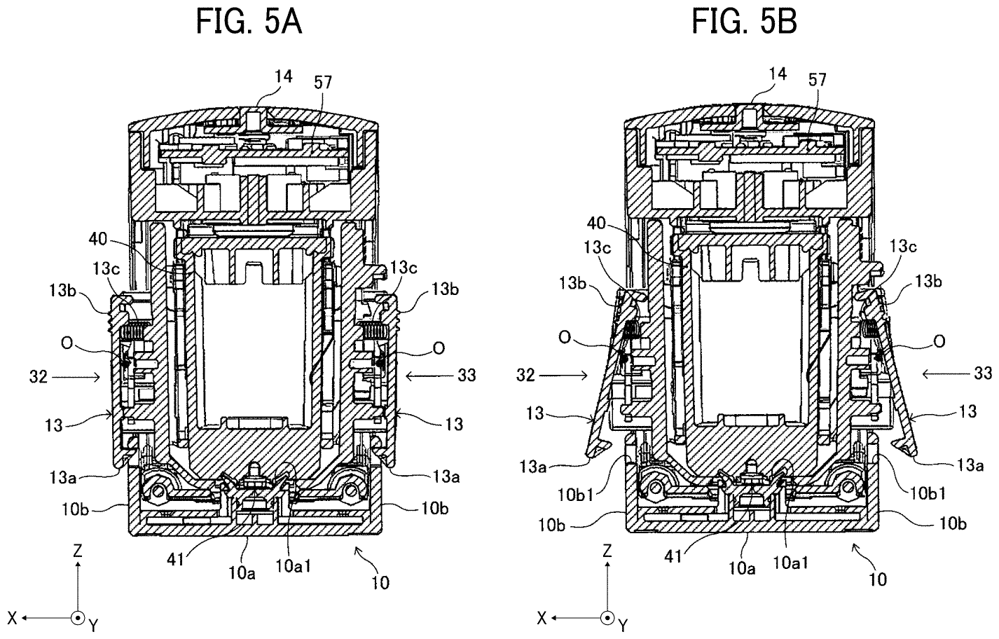

In the main body 1 of the present embodiment, the upper unit 2 is supported by the lower unit 3 so as to open and close with respect to the lower unit 3. An ink tank-integrated inkjet head 40, which is an ink cartridge including the recording device 41 and an ink tank as an integral part, is removably mounted inside the lower unit 3 (as described later with reference to FIGS. 5A and 5B). The recording device 41 that discharges ink droplets faces vertically downward. The inkjet head 40 discharges ink droplets from the recording device 41 to record an image, thus forming an image.

The recording face 30 of the main body 1 is provided with an opening 30a through which the recording device 41 of the inkjet head 40 mounted in the lower unit 3 is exposed outside, as illustrated in FIG. 2B. The recording device 41 of the inkjet head 40 includes a plurality of discharge orifices 41a serving as nozzles. Piezoelectric elements are driven to discharge ink droplets from the individual discharge orifices 41a.

As a drive source for discharging ink, the inkjet head 40 employs, e.g., an electromechanical conversion element, such as a piezoelectric actuator, using a laminated piezoelectric element or a thin-film piezoelectric element, an electrothermal conversion element such as a heat generating resistor, or an electrostatic actuator including diaphragm plates and opposed electrodes.

The ink (or liquid) discharged from the discharge orifices 41a of the recording device 41 is not particularly limited provided that the ink has a viscosity or surface tension enough to be discharged from discharge orifices 41a. However, preferably, the viscosity of the ink is not greater than 30 mPa·s under ordinary temperature and ordinary pressure or by heating or cooling. Specific examples of the ink (or liquid) include, hut are not limited to, a solution, a suspension, or an emulsion including, e.g., a solvent such as water or an organic solvent, a colorant such as dye or pigment, a functional material such as a polymerizable compound, a resin, or a surfactant, a biocompatible material such as deoxyribonucleic acid (DNA), amino acid, protein, or calcium, and an edible material such as a natural colorant. Such a solution, a suspension, or an emulsion may be used for, e.g., an inkjet ink, a surface treatment solution, a liquid for forming components of an electronic element or a light-emitting element or forming a resist pattern of an electronic circuit, or a material solution for three-dimensional fabrication.

The recording face 30 is provided with a position detection sensor 59 and four rollers, namely, a first left roller 17a, a second left roller 17b, a first right roller 18a, and a second right roller 18b. The position detection sensor 59 serves as a position detector that detects the position of the main body 1 on a recording material.

When a user moves the main body 1 in the scanning direction, the four rollers roll in contact with the surface of the recording material. The four rollers allow the user to move the main body 1 straight along the scanning direction. The four rollers also allow the main body 1 to reciprocate in the scanning direction. When the main body 1 moves, only the four rollers of the main body 1 contact the surface of the recording material and the surface of a table on which the recording material is placed, while keeping a given distance between the recording face 30 and the surface of the recording material. That is, the recording device 41 of the inkjet head 40 keeps a constant distance from the surface of the recording material to form a desired high-quality image.

The position detection sensor 59 is a sensor that detects, e.g., the distance to the surface of the recording material, the surface state (e.g., irregularities) of the recording material, and the distance of movement of the main body 1. For example, the position detection sensor 59 may be similar to a sensor used in an optical mouse (as a pointing device) for a personal computer. The position detection sensor 59 irradiates, with light, a place (i.e., recording material) on which the main body 1 is placed, to read the state of the irradiated place as a “pattern”. The position detection sensor 59 continuously detects how the “pattern” moves with respect to the movement of the position detection sensor 59, thus calculating an amount of movement.

FIG. 4 is a block diagram illustrating a part of an electric circuit of the main body 1. A control board 57 includes a central processing unit (CPU) 55 that performs various arithmetic processes and executes programs, a Bt board 52 such as a Bluetooth (registered trademark) board for short-range wireless communication, a random access memory (RAM) 53 that temporarily stores data, a read only memory (ROM) 54, and a recording controller 56. The control board 57 is fixed at a position on the back side of the USB connection port 6 in a hollow space of the upper unit 2.

The Bt board 52 performs data communication by short-range wireless communication (e.g., Bluetooth (registered trademark) communication) with an external device such as a smartphone or a tablet terminal. The ROM 54 stores, e.g., firmware for hardware control of the main body 1 and drive waveform data of the inkjet head 40. The recording controller 56 executes data processing for driving the inkjet head 40 and generates drive waveforms.

The control board 57 is electrically connected to a gyro sensor 58, the position detection sensor 59, a capping sensor 60, a light emitting diode (LED) lamp 14a, the inkjet head 40, the print button 14, the power button 15, and a battery 51.

The gyro sensor 58 detects the tilt and rotation angle of the main body 1 and transmits the result of detection to the control board 57. The LED lamp 14a is disposed inside an exterior cover made of a light transmissive material of the print button 14 and causes the print button 14 to emit light.

When the power button 15 is pressed to turn on the power of the main body 1, the power is supplied to each module. The CPU 55 starts a starting operation according to a program stored in the ROM 54 to load the program and data into the RAM 53. When receiving image data from an external device by short-range wireless communication, the recording controller 56 generates a drive waveform corresponding to the received image data. The recording controller 56 then controls the discharge of ink from the inkjet head 40 so as to form an image corresponding to a position on the surface of a recording material detected by the position detection sensor 59.

During acquisition of image data by short-range wireless communication from an external device, the control board 57 causes the LED lamp 14a to blink. Thus, the light-transmissive print button 14 emits light and blinks. Thereafter, when the acquisition of the image data is completed, the control board 57 continuously lights the LED lamp 14a to cause the print button 14 to continuously emit light. As the print button 14 continuously emits light, a user ascertains that the main body 1 has finished acquiring the image data. Therefore, the user places the main body 1 on a recording material and presses the print button 14.

On the other hand, after starting the continuous lighting control of the LED lamp 14a, the control board 57 waits for the print button 14 to be pressed. When the print button 14 is pressed, the control board 57 causes the LED lamp 14a to blink. That is, the control board 57 causes the print button 14 to emit light and blink. As the print button 14 blinks, the user starts moving the main body 1 in the scanning direction. In other words, the user starts manual scanning.

When finishing moving the main body 1, in other words, when finishing the manual scanning, the user presses the print button 14 again. In response to the print button 14 being pressed, the control board 57 turns off the LED lamp 14a to stop the light emission of the print button 14. In a case in which the user picks up the main body 1 from the recording material and places the main body 1 as is on, e.g., a desktop without pressing the print button 14, the position detection sensor 59 stops detecting the position when the user picks up the main body 1 from the recording material. The control board 57 turns off the LED lamp 14a at the time when the position detection sensor 59 stops detecting the position, thus stopping the light emission of the print button 14.

Note that the user does not need to keep pressing the print button 14 during manual scanning. In a case in which the user presses and releases the print button 14 prior to the manual scanning, the image forming operation based on the result of the detection made by the position detection sensor 59 is continued until the image formation is completed, until the print button 14 is pressed again, until the position detection sensor 59 stops detecting the position, or until the position detection sensor 59 detects that the main body 1 is separated from the recording material by a given distance or more. In the main body 1 of the present embodiment, the first left roller 17a and the second left roller 17b of a roller unit 17 and the first right roller 18a and the second right roller 18b of a roller unit 18 are disposed at positions deviating from the position of the recording device 41 in the scanning orthogonal direction. The first left roller 17a, the second left roller 17b, the first right roller 18a, and the second right roller 18b thus disposed do not contact an image formed on a recording material during movement of the main body 1. In short, the first left roller 17a, the second left roller 17b, the first right roller 18a, and the second right roller 18b do not disturb the image formed on the recording material.

Now, a description is given of a configuration and operation of a cap 10, which is a feature of the embodiments of the present disclosure.

According to the present embodiment, a cap 10 is attached to the main body 1, as illustrated in FIGS. 1A and 1B, to cap or cover a nozzle face 41b of the recording device 41. The nozzle face 41b, serving as an image forming face, is a surface of a nozzle plate having discharge orifices 41a, The nozzle face 41b serving as an image forming face is an area that forms an image on a recording material with the discharge orifices 41a formed in the area. The cap 10 includes a planar portion 10a that faces the recording face 30 of the main body 1 when the cap 10 is located at a capping position as illustrated in FIG. 1A, The planar portion 10a includes a capping section 10a1 that adheres to the nozzle face 41b and covers the discharge orifices 41a when the cap 10 is located at the capping position.

The cap 10 further includes a side wall portion lob erected on a planar face 10aF of the planar portion 10a as illustrated in FIGS. 1A and 1B. Such a configuration enhances the rigidity of the cap 10 (mainly, the rigidity against the bending of the planar portion 10a) as compared with the configuration of a cap that simply includes the planar portion 10a without the side wall portion 10b. The side wall portion 10b of the present embodiment has an advantage of reducing the length in the Y direction of an exposed gap, serving as a communication passage with the outside, between the recording face 30 of the main body 1 and the planar portion 10a of the cap 10 when the cap 10 is located at the capping position to cap or cover the nozzle face 41b of the recording face 30 of the main body 1 as illustrated in FIG. 1A. Accordingly, the side wall portion 10b of the present embodiment prevents foreign matter such as dust or dirt from invading and adhering to the recording device 41 (specifically, the nozzle face 41b and the discharge orifices 41a) of the inkjet head 40 and the position detection sensor 59 of the main body 1.

The cap 10 is movable, relative to the main body 1, between the capping position to cap or cover the nozzle face 41b as illustrated in FIG. 1A and a retracted position to be retracted from the nozzle face 41b as illustrated in FIG. 1B. Specifically, the cap 10 is rotatably attached to a shaft 11 disposed on the main body 1.

A biasing device 12 keeps supplying a biasing force to the cap 10 to urge the cap 10 to move in a direction from the capping position illustrated in FIG. 1A to the retracted position illustrated in FIG. 1B. Accordingly, the biasing force of the biasing device 12 rotates the cap 10 to a position at which the cap 10 abuts on the main body 1 and holds the cap 10 at the position (i.e., retracted position).

The retracted position is located on a side of the main body 1 in the scanning orthogonal direction, not on a side of the main body 1 in the scanning direction. At the retracted position, the cap 10 does not contact a recording material. Therefore, the cap 10 located at the retracted position does not disturb a user when the user moves the main body 1 along the surface of the recording material in the scanning direction. In addition, according to the present embodiment, since the cap 10 is located closer to the back face 34 of the main body 1, that is, closer to the fingertips of the user than to the wrist of the user, the cap 10 located at the retracted position does not disturb the user when the user holds the main body 1.

FIGS. 5A and 5B are cross-sectional views of the main body 1 along a line A-A illustrated in FIG. 2A.

In the present embodiment, a capping operation device 13 is disposed on each of the left side face 32 and the right side face 33 of the main body 1. The capping operation device 13 is attached to the lower unit 3 of the main body 1 rotatably about a shaft O. A compression spring 13c serving as a biasing device urges the capping operation device 13 to rotate in a direction from a non-holding position illustrated in FIG. 5B to a holding position illustrated in FIG. 5A.

A lower end portion of the capping operation device 13 serves as a holder that holds the cap 10 at the capping position illustrated in FIG. 5A. Specifically, the lower end portion of the capping operation device 13 is a claw 13a that fits into a holding opening 10b1 in the side wall portion lob of the cap 10. The claw 13a of the capping operation device 13 fitting into the holding opening 10b1 of the cap 10 hampers the biasing force of the biasing device 12 and prevents the cap 10 from moving from the capping position illustrated in FIG. 1A to the retracted position illustrated in FIG. 1B, thus holding the cap 10 at the capping position.

The compression spring 13c urges the capping operation device 13 in a direction in which the claw 13a fits into the holding opening 10b1 of the cap 10. Therefore, the claw 13a does not easily come off from the holding opening 10b1, thus stably holding the cap 10 at the capping position.

When the cap 10 is located at the capping position, as illustrated in FIG. 5A, the capping section 10a1 of the cap 10 adheres to the nozzle face 41b of the recording device 41 of the inkjet head 40 and covers the discharge orifices 41a on the nozzle face 41b. In short, the cap 10 is in a capping state at the capping position. The cap 10 in the capping state protects the nozzle face 41b and the discharge orifices 41a and prevents drying of the ink in the discharge orifices 41a.

In the present embodiment, the capping operation devices 13 release the cap 10 when each upper end portion (i.e., operation part 13b) of the two capping operation devices 13 disposed on the left side face 32 and the right side face 33, respectively, of the main body 1 is pushed toward the main body 1. Specifically, when the operation part 13b of the capping operation device 13 is pushed toward the main body 1, the capping operation device 13 rotates about the shaft O against the biasing force of the compression spring 13c from the holding position illustrated in FIG. 5A to the non-holding position illustrated in FIG. 5B. As a consequence, the claw 13a of the capping operation device 13 is disengaged from the holding opening 10b1 of the cap 10. Thus, the capping operation device 13 releases the cap 10.

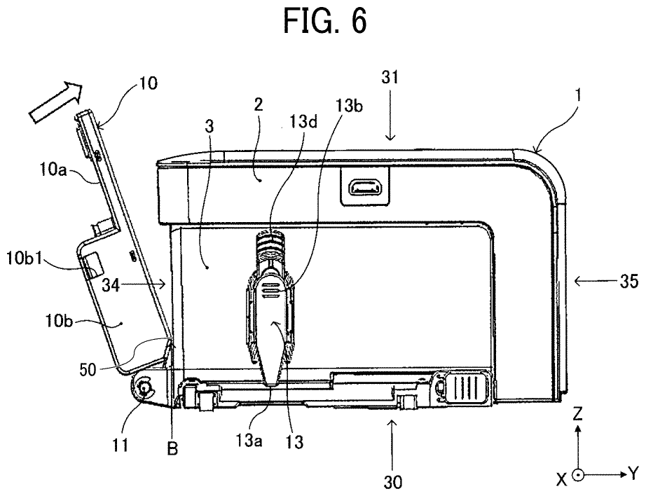

When the capping operation device 13 releases the cap 10, the biasing force of the biasing device 12 moves the cap 10 from the capping position illustrated in FIG. 1 A to the retracted position illustrated in FIG. 1B. When the cap 10 rotates and reaches the position at which the cap 10 abuts on the back face 34 of the main body 1, the cap 10 remains in contact with the back face 34 of the main body 1 due to the biasing force of the biasing device 12, thus being held at the position (i.e., retracted position). In order to alleviate the impact when the cap 10 abuts on the back face 34 of the main body 1, a cushion 50 such as rubber may be disposed on a contact portion B as illustrated in FIG. 6, The contact portion B includes at least one of a contact portion of the cap 10 that contacts the main body 1 and a contacted portion of the main body 1 that the cap 10 contacts.

In the present embodiment, in order to return the cap 10 from the retracted position illustrated in FIG. 1B to the capping position illustrated in FIG. 1A, a user rotates the cap 10 about the shaft 11 toward the capping position against the biasing force of the biasing device 12. At this time, since the capping operation devices 13 is located at the holding position by the biasing force of the compression spring 13c, the side wall portion 10b of the cap 10 having the holding opening 10b1 hits the claw 13a of the capping operation devices 13. In the present embodiment, a wall surface of the claw 13a hit by the side wall portion lob of the cap 10 is a slope as illustrated in FIGS. 5A and 5B. As the cap 10 is further rotated toward the capping position even after the side wall portion 10b of the cap 10 hits the slope of the claw 13a, the side wall portion 10b slides on the slope of the claw 13a and rotates the capping operation devices 13 from the holding position illustrated in FIG. 5A to the non-holding position illustrated in FIG. 5B against the biasing force of the compression spring 13c. As the cap 10 is rotated until the side wall portion lob exceeds the slope of the claw 13a, the cap 10 reaches the capping position at which the claw 13a of the capping operation device 13 fits into the holding opening 10b1 of the cap 10. Thus, the cap 10 is held at the capping position.

As described above, in the present embodiment, a user simply rotates the cap 10 from the retracted position illustrated in FIG. 1B to the capping position illustrated in FIG. 1A to return the cap 10 to the capping position and hold the cap 10 at the capping position.

A typical image forming apparatus often hinders a user from confirming an image formed on a recording material because a cap located at a retracted position hides the image during image formation.

In order to address such a situation, according to the present embodiment, the retracted position to which the cap 10 is retracted is outside an area in which the recording face 30 of the main body 1 is extended in the scanning direction, as viewed from, e.g., the top face 31 in a normal direction of the recording face 30 of the main body 1. Specifically, as illustrated in FIG. 2B, the retracted position of the cap 10 is a position outside an area in which a range C is extended in the scanning direction. Note that the range C illustrated in FIG. 2B corresponds to a range of the width (i.e., length in the scanning orthogonal direction) of a line of the discharge orifices 41a on the nozzle face 41b of the recording device 41 of the inkjet head 40. The retracted position thus defined prevents the cap 10 located at the retracted position from hiding an image formed on a recording material during image formation. Accordingly, the user can move the main body 1 while confirming the image formed on the recording material during image formation.

In particular, in the present embodiment, the retracted position is set as a position to which the cap 10 is retracted in an area E in which the nozzle face 41b serving as an image forming face is extended in the scanning orthogonal direction, as viewed from, e.g., the top face 31 in the normal direction of the recording face 30 of the main body 1. Such a configuration of the present embodiment allows the cap 10, which includes the capping section 10a1 that caps or covers the nozzle face 41b of the recording face 30, to move to the retracted position in a simple moving configuration. In other words, the cap 10 simply rotates about the shaft 11, thus moving to the retracted position.

Note that, in the present embodiment, the retracted position to which the cap 10 is retracted is located on a back side of the main body 1 on which the back face 34 is located, of positions in the area in which the recording face 30 is extended in the scanning orthogonal direction. Alternatively, the retracted position may be located on a front side of the main body 1 on which the front face 35 is located.

In the present embodiment, the operation part 13b of the capping operation device 13 used to move the cap 10 from the capping position to the retracted position is provided on each of the left side face 32 and the right side face 33 of outer wall faces of the main body 1 other than the bottom face (i.e., recording face 30) that faces a recording material at the time of image formation. Therefore, even in a case in which the main body 1 is placed on, e.g., a table with the recording face 30 facing downward, the operation part 13b does not contact the table surface. Accordingly, the operation part 13b is not operated unintentionally, That is, even in a case in which the main body 1 is placed on, e.g., a table with the recording face 30 facing downward, the cap 10 is stably held at the capping position. Accordingly, the capping section 10a1 of the cap 10 keeps capping the nozzle face 41b. Such a configuration allows a user to place the main body 1 on something with the recording face 30 facing downward without any problems when the user does not form an image with the HMP 100. Thus, the present embodiment enhances the usability of the HMP 100.

The operation part 13b of the capping operation device 13 may be disposed on the top face 31, the back face 34, or the front face 35 of the main body 1. Preferably, however, the operation part 13b of the capping operation device 13 is disposed on each of the left side face 32 and the right side face 33 of the main body 1 as in the present embodiment. A user places fingers (usually, the thumb and the middle finger or the ring finger) on the left side face 32 and the right side face 33 of the main body 1 to hold and use the main body 1. While holding the main body 1 in this manner for image formation, the user sandwiches the respective operation parts 13b of the two capping operation devices 13 from outside to operate the operation parts 13b with the fingers. Accordingly, when moving the cap 10 from the capping position to the retracted position to use the main body 1 for image formation, the user refrains from holding the main body 1 with the other hand or changing the way of holding the main body 1. Thus, according to the present embodiment, the HMP 100 is provided as a user-friendly apparatus.

In the present embodiment, as illustrated in FIG. 2B, the operation part 13b of the capping operation device 13 is arranged such that the position of the operation part 13b on each of the left side face 32 and the right side face 33 of the main body 1 overlaps or is identical to the position of the nozzle face 41b of the recording device 41 of the inkjet head 40 in the scanning orthogonal direction, which is a direction parallel to the recording face 30 of the main body 1. Specifically, in the scanning orthogonal direction, the respective operation parts 13b of the capping operation devices 13 are arranged in the range C illustrated in FIG. 2B corresponding to a range of the width (i.e., length in the scanning orthogonal direction) of the line of the discharge orifices 41a on the nozzle face 41b of the recording device 41 of the inkjet head 40.

In the present embodiment, when a user places the main body 1 on a recording material and starts image formation, the recording face 30 of the main body 1 is hidden and invisible to the user, hampering the user in confirming the location of the nozzle face 41b on the recording face 30, that is, the location of the discharge orifices 41a. In short, the user has some difficulties in accurately ascertaining the position, in the scanning orthogonal direction, of the image to be formed on the recording material before starting the image formation. In the present embodiment, the respective operation parts 13b of the capping operation devices 13 are arranged in the range C of the width (i.e., length in the scanning orthogonal direction) of the line of the discharge orifices 41a, that is, the maximum range in which the image is formed. Since the operation parts 13b are disposed on the left side face 32 and the right side face 33, respectively, of the main body 1, the user can see the operation parts 13b when the user places the main body 1 on the recording material and starts image formation. Such a configuration allows the user to confirm the position, in the scanning orthogonal direction (e.g., Y direction), of the image to be formed on the recording material with reference to the position of the operation parts 13b in the scanning orthogonal direction.

In particular, in the present embodiment, the range C of the width (i.e., length in the scanning orthogonal direction) of the line of the discharge orifices 41a matches the maximum width (i.e., length in the Y direction) of the respective operation parts 13b of the capping operation devices 13. In this case, the user can more reliably confirm the range in which the image is formed on the recording material.

In the present embodiment, as illustrated in FIG. 2B, a detection face 59a, as a sensing face, of the position detection sensor 59 that detects the position of the main body 1 on a recording material is arranged on the recording face 30 of the main body 1 on which the nozzle face 41b is also arranged. The position detection sensor 59 is disposed with a light-emitting portion and a lens exposed to emit light from the light-emitting portion to the recording material and receive light reflected from the recording material with a sensing portion. If foreign matter such as dust or dirt adheres to such a light-emitting portion or lens, erroneous detection may occur.

In order to prevent such a situation, as illustrated in FIG. 2A, the cap 10 of the present embodiment is configured to cover the detection face 59a of the position detection sensor 59 in addition to the nozzle face 41b of the recording device 41 of the inkjet head 40. Accordingly, the cap 10 of the present embodiment prevents foreign matter such as dust or dirt from adhering to the light-emitting portion and the lens.

In the present embodiment, a lock 13d is provided as an operation prohibiting device to prohibit an operation of the operation part 13b of the capping operation device 13 so that the cap 10 is stably held at the capping position.

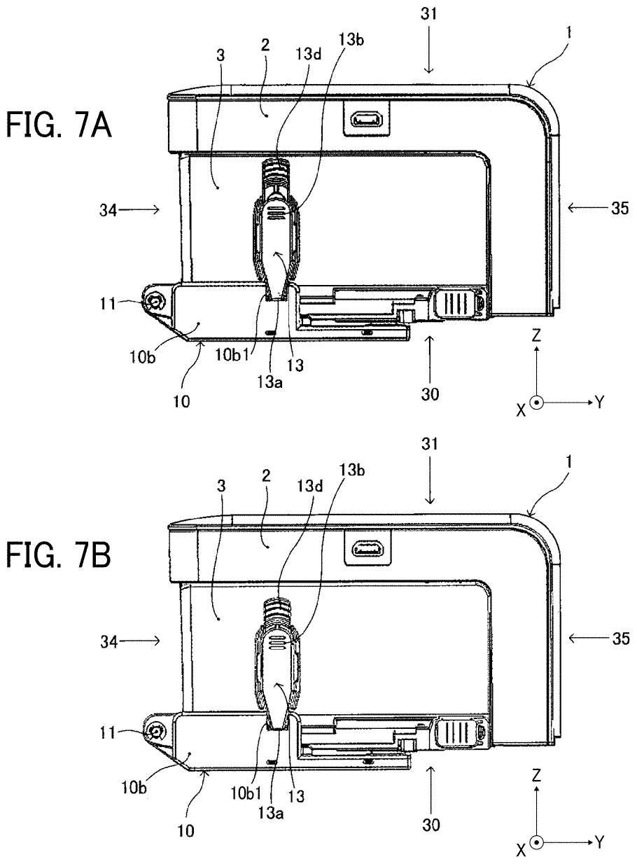

FIG. 7A is a side view of the main body 1, illustrating an unlocked state of the operation part 13b. Specifically, FIG. 7A illustrates a state in which the operation part 13b that has been locked by the lock 13d is unlocked.

FIG. 7B is a side view of the main body 1, illustrating a locked state of the operation part 13b. Specifically, FIG. 7B illustrates a state in which the operation part 13b is locked by the lock 13d.

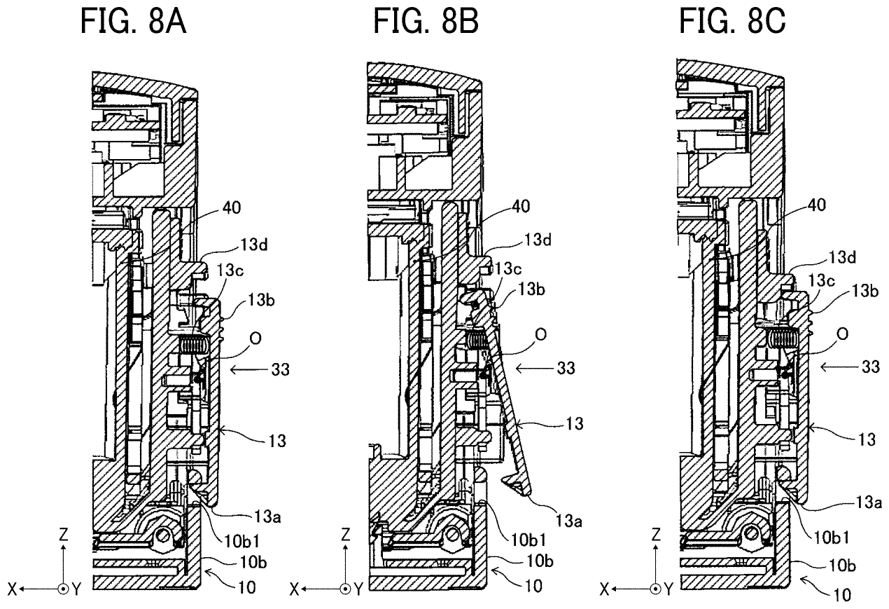

FIG. 8A is a cross-sectional view of the main body 1 along the line A-A illustrated in FIG. 2A with the capping operation device 13 located at the holding position in the unlocked state.

FIG. 8B is a cross-sectional view of the main body 1 along the line A-A illustrated in FIG. 2A with the capping operation device 13 located at the non-holding position in the unlocked state.

FIG. 8C is a cross-sectional view of the main body 1 along the line A-A illustrated in FIG. 2A with the capping operation device 13 located at the holding position in the locked state.

The lock 13d is an upper portion of the capping operation device 13 in FIGS. 7A to 8C. The lock 13d is attached to the main body 1 so as to be slidable in the vertical direction (i.e., Z direction). In a state in which the lock 13d is slid upward as illustrated in FIG. 7A, a space exists into which the operation part 13b of the capping operation device 13 is pushed toward the main body 1, as illustrated in FIGS. 8A and 8B. Therefore, when the operation part 13b of the capping operation device 13 is pushed toward the main body 1, the capping operation device 13 rotates about the shaft O against the biasing force of the compression spring 13c from the holding position illustrated in FIG. 5A to the non-holding position illustrated in FIG. 5B. At this time, the operation part 13b is in the unlocked state in which the operation part 13b that has been locked by the lock 13d is unlocked.

By contrast, in a state in which the lock 13d is slid downward as illustrated in FIG. 7B, the lock 13d enters the space into which the operation part 13b of the capping operation device 13 is pushed toward the main body 1, as illustrated in FIG. 8C. As a consequence, when the operation part 13b of the capping operation device 13 is pushed toward the main body 1, the lock 13d interferes with the push, hampering the capping operation device 13 in rotating from the holding position illustrated in FIG. 5A to the non-holding position illustrated in FIG. 8B. At this time, the operation part 13b is in the locked state in which the operation part 13b is locked by the lock 13d.

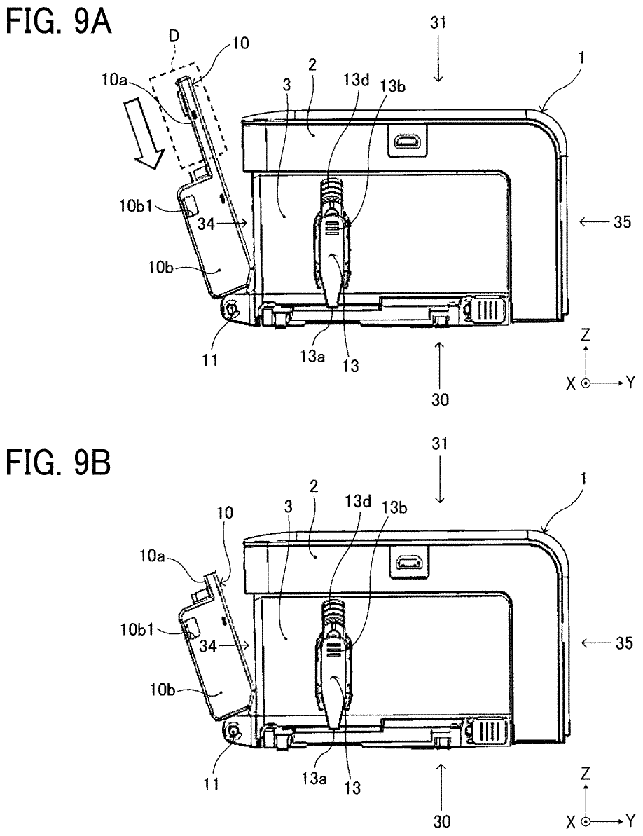

In the present embodiment, as illustrated in FIG. 2A, the cap 10 is relatively long in a longitudinal direction of the cap 10 to cover the detection face 59a of the position detection sensor 59 in addition to the nozzle face 41b of the recording device 41 of the inkjet head 40. Therefore, as illustrated in FIG. 9A, an upper longitudinal end portion of the cap 10 may be located higher than the top face 31 of the main body 1 when the cap 10 is located at the retracted position and may disturb a user when the user handles the main body 1 at the time of image formation.

In order to prevent such a situation, according to the present embodiment, a longitudinal length of the cap 10 may be changeable. For example, as illustrated in FIG. 9A, a longitudinal end portion D, as an upper longitudinal end portion, of the cap 10 is retractable to the other longitudinal end portion of the cap 10. Specifically, for example, the longitudinal end portion D of the cap 10 may be slid or folded back and thus retracted to the other longitudinal end portion of the cap 10.

In the present embodiment, as illustrated in FIG. 4, the main body 1 includes the capping sensor 60 on the recording face 30 of the main body 1. The capping sensor 60 serves as a cap detector that detects that the cap 10 is located at one of the capping position and the retracted position. Based on an output signal of the capping sensor 60, the control board 57 ascertains whether the cap 10 is located at the capping position. Accordingly, for example, when the cap 10 is located at the capping position, the control board 57 controls the main body 1 not to start the image forming operation in response to the print button 14 being pressed. In this case, an unfavorable situation is prevented in which the image forming operation is performed with the cap 10 being located at the capping position.

The control board 57 may perform control to notify a user that the cap 10 is located at the retracted position, for example. Such control prevents the user from forgetting to locate the cap 10 at the capping position,

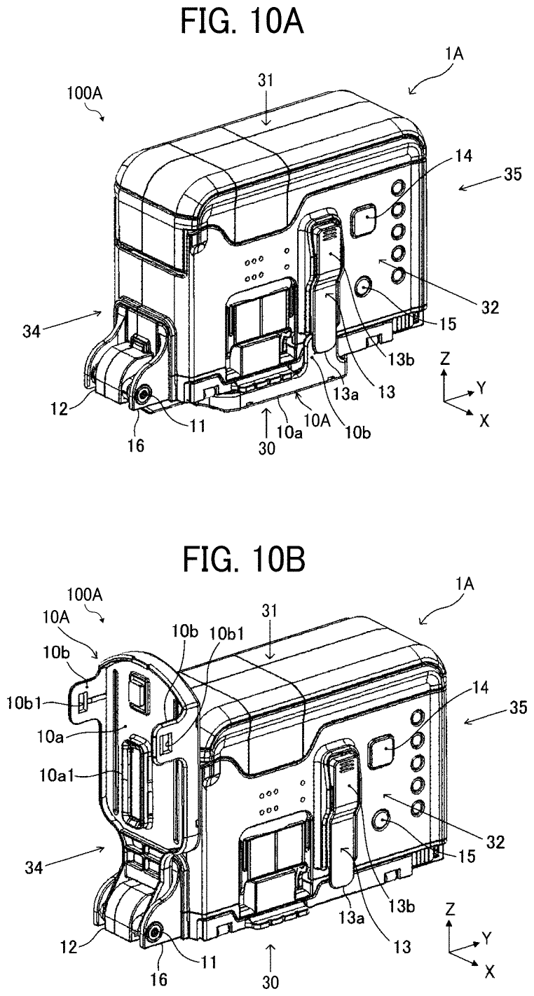

Referring now to FIGS. 10A to 12, a description is given of a first variation as a variation of the embodiment described above.

FIGS. 10A and 10B are external perspective views of a main body 1A (serving as an apparatus body) of an HMP 100A according to the first variation, as viewed from diagonally above.

Although the configuration of the main body 1A of the first variation is slightly changed from the configuration of the main body 1 of the embodiment described above, the basic configuration of the main body 1A of the first variation is almost the same as the configuration of the main body 1 of the embodiment described above. Therefore, like reference numerals are given to identical or corresponding constituent elements such as parts and members having the same functions, and redundant descriptions thereof are omitted unless otherwise required.

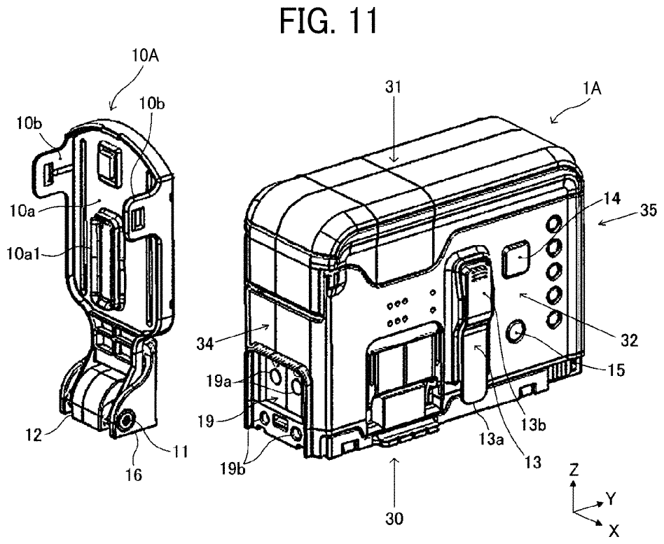

As in the embodiment described above, according to the first variation, a cap 10A is attached to the main body 1A, as illustrated in FIGS. 10A and 10B, to cap or cover the nozzle face 41b of the recording device 41. As described above, the nozzle face 41b, serving as an image forming face, is a surface of a nozzle plate having the discharge orifices 41a. However, as illustrated in FIG. 11, the cap 10A of the first variation is removable from the main body 1A. Accordingly, when using the main body 1A, that is, when moving the main body 1A in the scanning direction on a surface of a recording material to form an image on the recording material, a user can use the main body 1A without the cap 10A. That is, the cap 10A does not disturb the user when the user uses the main body 1, thus enhancing the user-friendliness.

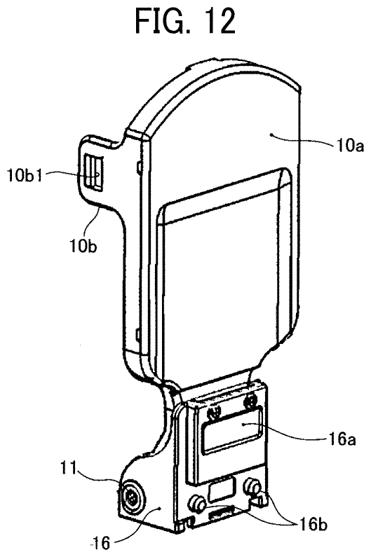

FIG. 12 is a perspective view of the cap 10A removed from the main body 1A according to the first variation.

In the first variation, the cap 10A includes a shaft support 16 that pivotally supports the shaft 11. The shaft support 16 is attachable to and removable from an attachment/detachment portion 19 on a side of the main body 1A provided with the back face 34. As illustrated in FIG. 11, the attachment/detachment portion 19 of the main body 1A includes a magnet 19a and a positioning hole 19h. On the other hand, as illustrated in FIG. 12, the shaft support 16 of the cap 10A includes a metal plate 16a as a magnetic body at a position corresponding to the magnet 19a of the attachment/detachment portion 19 of the main body 1A. In addition, as illustrated in FIG. 12, the shaft support 16 of the cap 10A includes a positioning projection 16b at a position corresponding to the positioning hole 19b of the attachment/detachment portion 19 of the main body 1A.

A user attaches the cap 10A to the main body 1A such that the positioning projection 16b of the shaft support 16 of the cap 10A fits into the positioning hole 19h of the attachment/detachment portion 19 of the main body 1. Accordingly, the magnet 19a of the attachment/detachment portion 19 of the main body 1A magnetically attracts the metal plate 16a of the shaft support 16 of the cap 10A. Thus, a magnet force of the magnet 19a prevents an easy removal of the cap 10A from the main body 1A and keeps the cap 10A being positioned at an appropriate position and attached to the main body 1A.

Although the cap 10A is magnetically attachable to the main body 1A in the first variation, the cap 10A is attachable to the main body 1A by any way. For example, the cap 10A may be mechanically engaged with the main body 1A by a snap-fit way.

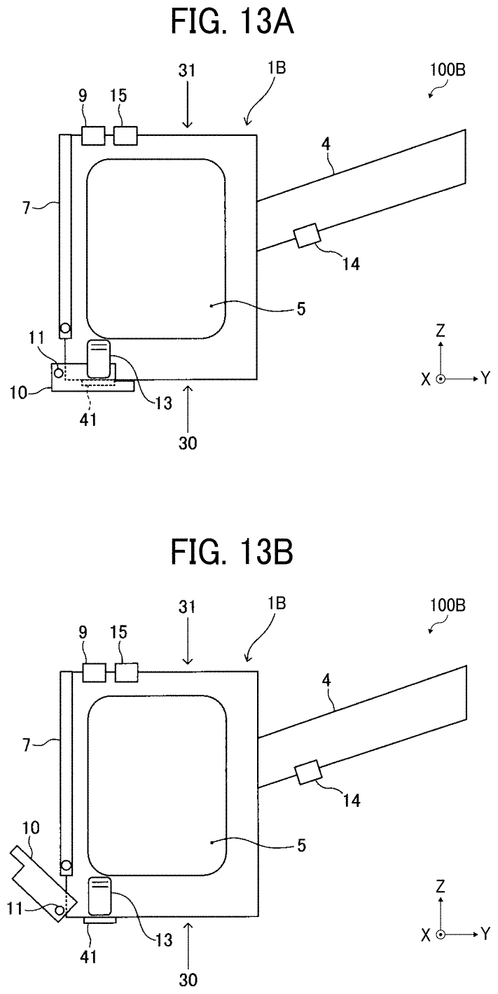

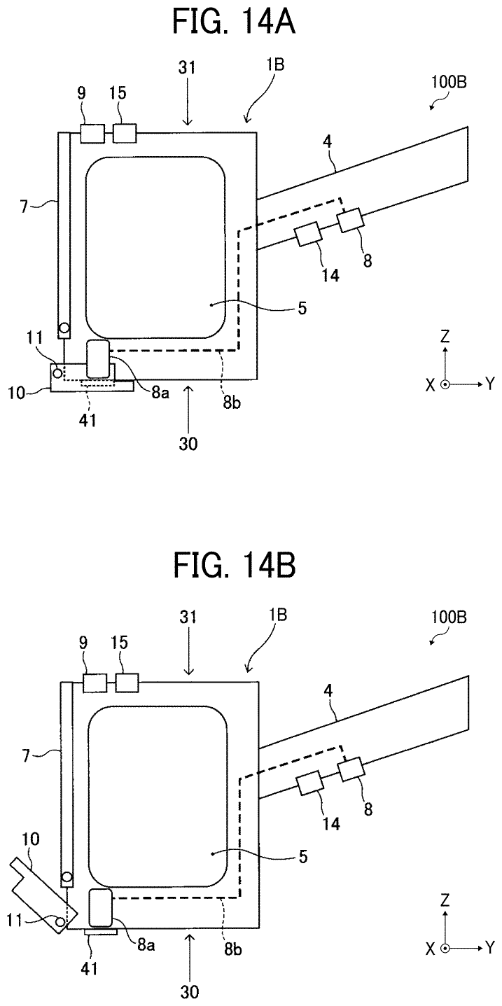

Referring now to FIGS. 13A to 1413, a description is given of a second variation as another variation of the embodiment described above.

FIGS. 13A and 13B are side views of a main body 1B (serving as an apparatus body) of an HMP 100B according to an example of the second variation.

Although the configuration of the main body 1B of the second variation is slightly changed from the configuration of the main body 1 of the embodiment described above, the basic configuration of the main body 1B of the second variation is almost the same as the configuration of the main body 1 of the embodiment described above. Therefore, like reference numerals are given to identical or corresponding constituent elements such as parts and members having the same functions, and redundant descriptions thereof are omitted unless otherwise required.

The configuration of the main body 1B of the second variation is mainly different from the configuration of the main body 1 of the embodiment described above in that the main body 1B includes a handle 4 for a user to grip and a touch panel 5 serving as an image display for a user to operate. The touch panel 5 also displays various types of images. In the second variation, a user grips the handle 4 to hold and use the main body 1B in posture directing the recording face 30 vertically downward in the −Z direction with respect to the XY plane in FIGS. 13A and 13B, while directing the top face 31 vertically upward in the Z direction. The scanning direction (i.e., printing direction) is the X direction or the −X direction as in the embodiment described above.

As in the embodiment described above, the ink tank-integrated inkjet head 40, which is an ink cartridge including the recording device 41 and an ink tank as an integral part, is removably mounted in the main body 1B of the second variation. The user presses a cartridge cover release button 9 provided on the top face 31 of the main body 1B to open a cartridge cover 7 of the main body 1B, thus removing or attaching the inkjet head 40 (i.e., ink cartridge) from or to the main body 1B. In the second variation, the power button 15 is disposed on the top face 31 of the main body 1B, whereas the print button 14 serving as an instruction operation device to instruct image formation is disposed on the handle 4.

As in the embodiment described above, according to the second variation, the cap 10 is attached to the main body 1B, as illustrated in FIGS. 13A and 13B, to cap or cover the nozzle face 41b of the recording device 41. As described above, the nozzle face 41b, serving as an image forming face, is a surface of a nozzle plate having the discharge orifices 41a. As in the embodiment described above, the cap 10 is rotatably attached to the shall 11 disposed on the main body 1B in the second variation. The capping operation devices 13 releases the cap 10 when the user pushes the upper end portion of the capping operation device 13 toward the main body 1, When the capping operation device 13 releases the cap 10, the biasing force of the biasing device 12 moves the cap 10 from the capping position illustrated in FIG. 13A to the retracted position illustrated in FIG. 13B.

In the second variation, similarly to the embodiment described above, the user operates the capping operation device 13 disposed on each of the left side face 32 and the right side face 33 of the main body 1 to release the cap 10 held by the capping operation device 13. However, other configurations are adoptable.

For example, as illustrated in FIGS. NA and 14B, the cap 10 may be held by a capping holder 8a instead of the capping operation device 13. A capping operation part 8 is also disposed on, e.g., the handle 4 to receive an operation to release the cap 10 held by the capping holder 8a. A connector 8b connects or couples the capping operation part 8 to the capping holder 8a so as to release the cap 10 held by the capping holder 8a as the user moves the capping operation part 8.

The connector 8b may electrically transmit the movement of the capping operation part 8 to drive a driving portion of the capping holder 8a to release the cap 10 held by the capping holder 8a. Alternatively, the connector 8b may mechanically transmit the movement of the capping operation part 8 to move the capping holder 8a and release the cap 10 held by the capping holder 8a.

The capping operation part 8, which receives the operation to release the cap 10 held by the capping holder 8a, is preferably disposed on the handle 4 that is gripped by the user when the user uses the main body 1B, as in the second variation. Such a configuration allows the user to operate the capping operation part 8 in the same state as the state in which the user holds the main body 1B for image formation. Accordingly, when moving the cap 10 from the capping position to the retracted position to use the main body 1B for image formation, the user refrains from holding the main body 1B with the other hand or changing the way of holding the main body 1B. Thus, the HMP 100B is provided as a user-friendly apparatus.

The present embodiment and the variations described above have been described as applicable to an inkjet HMP. However, one or more of the embodiments of the present disclosure are applicable to an apparatus employing another image forming system or method. For example, one or more of the embodiments of the present disclosure are applicable to a recording device employing an appropriate method such as a heat-sensitive method or a thermal transfer method.

Although the main body 1 and the cap 10 have been described as separate components, the main body 1 may include the cap 10 according to an embodiment of the present disclosure.

Although specific embodiments and examples are described, the embodiments and examples according to the present disclosure are not limited to those specifically described herein. Several aspects of the image forming apparatus are exemplified as follows.

Initially, a description is given of a first aspect.

According to the first aspect, an image forming apparatus (e.g., HMP 100), movable to form an image on a recording medium, includes an image forming device (e.g., recording device 41), an apparatus body (e.g., main body 1), and a cap (e.g., cap 10), The image forming device includes an image forming face (e.g., nozzle face 41b) that is configured to face the recording medium (e.g., recording material P). The image forming device is configured to form the image on the recording medium. The apparatus body is configured to support the image forming device. The cap is movable relative to the apparatus body between a capping position to cover the image forming face and a retracted position to be retracted from the image forming face. The retracted position is outside an area in which the image forming face is extended in a scanning direction, as viewed in a normal direction of the image forming face (e.g., in the Z direction).

In the present aspect, the cap is retracted to a position outside the area in which the image forming face is extended in the scanning direction, as viewed in the normal direction of the image forming face (e.g., in the Z direction). The retracted position thus defined prevents the cap located at the retracted position from hiding the image formed on the recording material during image formation. Accordingly, a user can confirm the image formed on the recording material without being hindered by the cap during the image formation.

A description is now given of a second aspect.

According to the second aspect, in the image forming apparatus of the first aspect, the cap is rotatable about a shaft (e.g., shaft 11) between the capping position and the retracted position.

According to the present aspect, the cap is movable between the capping position and the retracted position in a simple configuration.

A description is now given of a third aspect.

According to the third aspect, in the image forming apparatus of the second aspect, the cap (e.g., cap 10A) includes a shaft support (e.g., shaft support 16) configured to pivotally support the shaft. The cap is removable from the apparatus body (e.g., main body 1A) together with the shaft support.

Accordingly, when moving the apparatus body of the image forming apparatus for image formation, a user can use the main body without the cap. That is, the cap does not disturb the user when the user uses the main body, thus enhancing the user-friendliness.

A description is now given of a fourth aspect. According to the fourth aspect, in the image forming apparatus of the third aspect, the cap is configured to maintain a state of being magnetically attached to the apparatus body. In other words, the cap is magnetically attached to the apparatus body.

That is, a user can easily attach and remove the cap to and from the apparatus body. Thus, the present aspect enhances the user-friendliness of the image forming apparatus.

A description is now given of a fifth aspect.

According to the fifth aspect, in the image forming apparatus of the fourth aspect, one of the cap and the apparatus body includes a magnet (e.g., magnet 19a). Another one of the cap and the apparatus body includes a metal part (e.g., metal plate 16a) that is attracted by the magnet.

As the cap is magnetically attachable to the apparatus body, the cap is attachable to and removable from the apparatus body with a simple configuration at low cost.

A description is now given of a sixth aspect.

According to the sixth aspect, in the image forming apparatus of any one of the first to fifth aspects, the retracted position is in an area in which the image forming face is extended in a direction orthogonal to the scanning direction, as viewed in the normal direction of the image forming face. In other words, the retracted position is in an area deviating from the image forming face in a direction orthogonal to the scanning direction, as viewed in the normal direction of the image forming face.

According to the present aspect, the cap that caps or covers the image forming face is movable to the retracted position in a simple moving configuration.

A description is now given of a seventh aspect.

According to the seventh aspect, the image forming apparatus of any one of the first to sixth aspects further includes a biasing device (e.g., biasing device 12) configured to urge the cap to move in a direction from the capping position to the retracted position. The cap is configured to contact a contacted portion of the apparatus body due to a biasing force of the biasing device at the retracted position.

Accordingly, the cap is held at the retracted position in a simple configuration.

A description is now given of an eighth aspect.

According to the eighth aspect, the image forming apparatus of the seventh aspect further includes a cushion (e.g., cushion 50) on at least one of the contacted portion of the apparatus body and a contact portion of the cap configured to contact the contacted portion of the apparatus body.

Accordingly, the impact is alleviated when the cap abuts on the apparatus body due to the biasing force of the biasing device at the retracted position.

A description is now given of a ninth aspect.

According to the ninth aspect, the image forming apparatus of any one of the first to eighth aspects further includes a position detector (e.g., position detection sensor 59) that is configured to face the recording medium and detect a position of the apparatus body on the recording medium when the image forming device forms the image on the recording medium.

The position detector includes a detection face (e.g., detection face 59a), The cap is configured to cover the detection face at the capping position.

Accordingly, the position detector is also protected with the cap.

A description is now given of a tenth aspect.

According to the tenth aspect, the image forming apparatus of any one of the first to ninth aspects further includes a cap detector (e.g., capping sensor 60) that is configured to detect that the cap is located at one of the capping position and the retracted position.

Accordingly, the control is performed as appropriate for the location of the cap.

A description is now given of an eleventh aspect.

According to the eleventh aspect, in the image forming apparatus of any one of the first to tenth aspects, the cap includes a planar portion (e.g., planar portion 10a) and a wall portion (e.g., side wall portion 10b). The planar portion includes a planar face (e.g., planar face 10aF) and a capping section (e.g., capping section 10a1) that is configured to cover the image forming face. The wall portion is erected on the planar face.

Such a configuration enhances the rigidity of the cap (mainly, the rigidity against the bending of the planar portion).

A description is now given of a twelfth aspect.

According to the twelfth aspect, in the image forming apparatus of any one of the first to eleventh aspects, a longitudinal length of the cap is changeable.

Accordingly, the cap located at the retracted position is less likely to disturb a user when the user handles the apparatus body. Thus, the present aspect enhances the usability of the image forming apparatus.

A description is now given of a thirteenth aspect.

According to the thirteenth aspect, in the image forming apparatus of any one of the first to twelfth aspects, the image forming device is a liquid discharge head that includes a nozzle (e.g., discharge orifice 41a) on the image forming face and that is configured to discharge liquid from the nozzle.

In the present aspect, the cap located at the capping position prevents drying of ink.

A description is now given of a fourteenth aspect.

According to the fourteenth aspect, the image forming apparatus of any one of the first to thirteenth aspects further includes a display (e.g., touch panel 5) such as an image display or a screen display disposed on a side face of the apparatus body and a capping operation part (e.g., operation part 13b of the capping operation device 13) disposed on the side face provided with the display, to receive an operation to move the cap to the retracted position.

Accordingly, the image forming apparatus receives the operation to move the cap to the retracted position with a simple configuration.

A description is now given of a fifteenth aspect.

According to the fifteenth aspect, the image forming apparatus of any one of the first to thirteenth aspects further includes a handle (e.g., handle 4), an instruction operation device (e.g., print button 14), and a capping operation part (e.g., capping operation part 8). The handle projects from the apparatus body and is holdable to move the image forming apparatus. The instruction operation device is disposed on the handle to receive an image forming instruction. The capping operation part is disposed on the handle to receive an operation to move the cap to the retracted position.

Such a configuration allows a user to operate the capping operation part in the same state as the state in which the user holds the apparatus body of the image forming apparatus for image formation. Accordingly, when moving the cap from the capping position to the retracted position to use the apparatus body for image formation, the user refrains from holding the apparatus body with the other hand or changing the way of holding the apparatus body. Thus, the present aspect enhances the usability of the image forming apparatus.

A description is now given of a sixteenth aspect.

According to the sixteenth aspect, a body (e.g., main body 1) of an image forming apparatus (e.g., HMP 100) includes a cap (e.g., cap 10). The body is configured to support an image forming device (e.g., recording device 41) that is configured to form an image on a recording medium (e.g., recording material P), The cap is movable between a capping position to cover an image forming face (e.g., nozzle face 41b) of the image forming device and a retracted position to be retracted from the image forming face. The retracted position is outside an area in which the image forming face is extended in a scanning direction of the body, as viewed in a normal direction of the image forming face (e.g., in the Z direction).

In the present aspect, the cap is retracted to a position outside the area in which the image forming face is extended in the scanning direction, as viewed in the normal direction of the image forming face (e.g., in the Z direction), The retracted position thus defined prevents the cap located at the retracted position from hiding the image formed on the recording material during image formation. Accordingly, a user can confirm the image formed on the recording material without being hindered by the cap during the image formation.

According to the embodiments of the present disclosure, a user can confirm an image formed on a recording material without being hindered by a cap during image formation.

Although the present disclosure makes reference to specific embodiments, it is to be noted that the present disclosure is not limited to the details of the embodiments described above. Thus, various modifications and enhancements are possible in light of the above teachings, without departing from the scope of the present disclosure. It is therefore to be understood that the present disclosure may be practiced otherwise than as specifically described herein. For example, elements and/or features of different embodiments may be combined with each other and/or substituted for each other within the scope of the present disclosure. The number of constituent elements and their locations, shapes, and so forth are not limited to any of the structure for performing the methodology illustrated in the drawings.

What is claimed is:

1. An image forming apparatus movable to form an image on a recording medium, the image forming apparatus comprising:
an image forming device including an image forming face configured to face the recording medium, the image forming device being configured to form the image on the recording medium;
an apparatus body configured to support the image forming device; and
a cap movable relative to the apparatus body between a capping position to cover the image forming face and a retracted position to be retracted from the image forming face,
the retracted position being outside an area in which the image forming face is extended in a scanning direction, as viewed in a normal direction of the image forming face.

2. The image forming apparatus according to claim 1,
wherein the cap is rotatable about a shaft between the capping position and the retracted position.

3. The image forming apparatus according to claim 2,
wherein the cap includes a shaft support configured to pivotally support the shaft, and
wherein the cap is removable from the apparatus body together with the shaft support.

4. The image forming apparatus according to claim 3,
wherein the cap is magnetically attached to the apparatus body.

5. The image forming apparatus according to claim 4,
wherein one of the cap and the apparatus body includes a magnet and
wherein another one of the cap and the apparatus body includes a metal part attracted by the magnet.

6. The image forming apparatus according to claim 1,
wherein the retracted position is in an area deviating from the image forming face in a direction orthogonal to the scanning direction, as viewed in the normal direction of the image forming face.

7. The image forming apparatus according to claim 1, further comprising a biasing device configured to urge the cap to move in a direction from the capping position to the retracted position,
wherein the cap is configured to contact a contacted portion of e apparatus body due to a biasing force of the biasing device at the retracted position.

8. The image forming apparatus according to claim 7, further comprising a cushion on at least one of the contacted portion of the apparatus body and a contact portion of the cap configured to contact the contacted portion of the apparatus body.

9. The image forming apparatus according to claim 1, further comprising a position detector configured to face the recording medium and detect a position of the apparatus body on the recording medium when the image forming device forms the image on the recording medium,
wherein the position detector includes a detection face, and
wherein the cap is configured to cover the detection face at the capping position.

10. The image forming apparatus according to claim 1, further comprising a cap detector configured to detect that the cap is located at one of the capping position and the retracted position.

11. The image forming apparatus according to claim 1,
wherein the cap includes: a planar portion including: a planar face; and a capping section configured to cover the image forming face; and a wall portion erected on the planar face.

12. The image forming apparatus according to claim 1,
wherein a longitudinal length of the cap is changeable.

13. The image forming apparatus according to claim 1,
wherein the image forming device is a liquid discharge head including a nozzle on the image forming face and configured to discharge liquid from the nozzle.

14. The image forming apparatus according to claim 1, further comprising:
a display disposed on a side face of the apparatus body; and
a capping operation part disposed on the side face to receive an operation to move the cap to the retracted position.

15. The image forming apparatus according to claim 1, further comprising:
a handle projecting from the apparatus body and holdable to move the image forming apparatus;
an instruction operation device disposed on the handle to receive an image forming instruction; and
a capping operation part disposed on the handle to receive an operation to move the cap to the retracted position.

16. A body of an image forming apparatus, the body being configured to support an image forming device configured to form an image on a recording medium, the body comprising a cap movable between a capping position to cover an image forming face of the image forming device and a retracted position to be retracted from the image forming face,
the retracted position being outside an area in which the image forming face is extended in a scanning direction of the body, as viewed in a normal direction of the image forming face.
